(19) United States
(12) Patent Application Publication
(10) Pub. No.: US 2008/0068317 A1
(43) Pub. Date: Mar. 20, 2008

(54) DISPLAY APPARATUS

(76) Inventors: Shigesumi Araki, Ishikawa-gun (JP); Kazuhiro Nishiyama, Kanazawa-shi (JP); Mitsutaka Okita, Hakusan-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/764,494

(22) Filed: Jun. 18, 2007

(30) Foreign Application Priority Data
Jun. 19, 2006 (JP) 2006-168772

(51) Int. Cl. G09G 3/36

(52) U.S. Cl. 345/88

(57) ABSTRACT

A display apparatus includes a video signal converter unit which converts input video signals of n colors (n is an integer equal to or larger than 2) into converted video signals of at least (n+1) colors, a video signal generator unit which, on the basis of the input video signal of at least one color, generates converted video signals of new (n+1) colors with the luminance of two or more converted video signals being improved, a display panel which displays (n+1) images sequentially on the basis of the converted video signals of the new (n+1) colors, and a backlight which switches between light sources of (n+1) colors for illumination sequentially in accordance with the images displayed on the display panel.

### CROSS-REFERENCE TO RELATED APPLICATIONS

This application is based upon and claims the benefit of priority from prior Japanese Patent Application No. 2006-168772, filed Jun. 19, 2006, the entire contents of which are incorporated herein by reference.

### BACKGROUND OF THE INVENTION

1. Field of the Invention

This invention relates to a field sequential display apparatus which creates a color display in time division, and more particularly to a display apparatus capable of adjusting the color gamut easily and creating a bright display.

2. Description of the Related Art

Liquid-crystal display devices have been widely used as display panels for displaying images in computers, car navigation systems, TV sets, or the like.

In a general liquid-crystal display device, to create a color display, there is provided a color filter composed of, for example, colored layers of three primary colors: red (R), green (G), and blue (B). The RGB colored layers are arranged so as to correspond to the respective pixels. The light transmittance of each of the pixels is controlled, thereby realizing a full color display. A method of using a color filter is at a disadvantage in that it is not easy to achieve a high-definition configuration, because a display pixel has to be composed of three color pixels.

As the technique for overcoming the drawbacks, a field sequential liquid-crystal display device has been provided.

In the field sequential driving method, red light, green light, and blue light are turned on in sequence. The corresponding image is displayed on the display panel in synchronization with the lighted color, thereby creating a color image making use of the persistence of vision of eyes. In the field sequential driving method, a color filter is not needed and an image can be displayed with a simple configuration because one display pixel is realized by one pixel.

As for the color reproduction of red, green, and blue, since an ordinary liquid-crystal display device generally uses a color filter conforming to such a standard as the European Broadcasting Union (EBU) standard, the realization of a more accurate color gamut causes the transmittance to decrease. However, in the field sequential driving method using red, green, and blue LED light sources, although a higher color gamut than in the EBU standard can be realized easily, this might leads to excessive specifications in some situations.

The field sequential driving method has the following problems: the occurrence of a monochromatic coloring phenomenon known as color breakup and a decrease in the strength of a display signal caused by time-division driving. Color breakup is a phenomenon in which the edge part of a moving object is colored by the time difference in display timing between red, green, and blue when a moving image is displayed.

As a method of alleviating the color breakup, a method of displaying an image by driving four or more subfields of white and complementary colors in addition to red, green, and blue sequentially in displaying one field has been disclosed (Jpn. Pat. Appln. KOKAI Publication No. 2005-233982).

When four or more subfields are driven sequentially in time division using the technique written in Jpn. Pat. Appln. KOKAI Publication No. 2005-233982, the luminance decreases as compared with a case where three subfields of red, green, and blue are driven sequentially.

### BRIEF SUMMARY OF THE INVENTION

According to a first aspect of the present invention, there is provided a display apparatus comprising: a video signal converter unit which converts input video signals of n colors (n is an integer equal to or larger than 2) into converted video signals of at least (n+1) colors and which generates the converted video signals of (n+1) colors to improve the luminance of the input video signal of at least one color; a display panel which displays (n+1) images sequentially on the basis of the converted video signals of (n+1) colors; and a backlight which switches between light sources of (n+1) colors for illumination sequentially in accordance with the images displayed on the display panel.

According to a second aspect of the present invention, there is provided a display apparatus comprising: a video signal generator unit which, on the basis of individual input video signals of n colors (n is an integer equal to or larger than 2), generates input video signals of new n colors with the luminance of at least one of the input video signals being improved; a video signal converter unit which converts the input video signals of the new n colors into converted video signals of at least (n+1) colors; a display panel which displays (n+1) images sequentially on the basis of the converted video signals of (n+1) colors; and a backlight which switches between light sources of (n+1) colors for illumination sequentially in accordance with the images displayed on the display panel.

Advantages of the invention will be set fourth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of a liquid-crystal display device according to an embodiment of the invention;

FIG. 2 is a diagram to explain a field sequential driving method using four subfields of RGBW as a comparative example;

FIG. 3 is a diagram to explain a field sequential driving method using four subfields of RGBW in the liquid-crystal display device of the embodiment;

FIG. 4 is a flowchart to explain a rough procedure for a video signal converter unit;

FIG. 5 is a diagram to explain an example of setting data; and

FIG. 6 shows practical examples using the liquid-crystal display device of the embodiment.

### DETAILED DESCRIPTION OF THE INVENTION

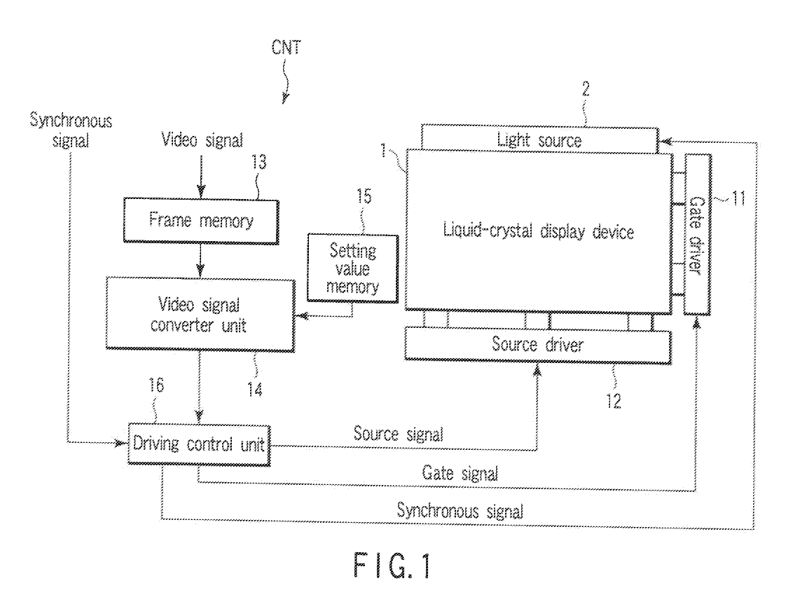

FIG. 1 is a block diagram showing the configuration of a liquid-crystal display device according to an embodiment of the invention.

The liquid-crystal display device comprises a liquid-crystal display panel 1 for displaying an image, a light source 2 for illuminating the liquid-crystal display panel 1, and a display control circuit CNT for controlling a display operation.

The liquid-crystal display panel 1 has such a structure as has a liquid-crystal layer held between an array substrate (not shown) and a counter-substrate (not shown) which makes a pair of electrode substrates. On the array substrate, a plurality of pixel electrodes arranged in a matrix are provided. On the counter-substrate, a black matrix for preventing light leakage and a counter-electrode are provided. Then, the individual pixel electrodes, individual counter-electrodes, and the liquid-crystal layer constitute the individual pixels. The liquid-crystal display panel 1 is not provided with a color filter.

A light source 2 includes light emitting diodes (LEDs) for emitting light of three primary colors (red, green, and blue [R, G and B] light) and means for controlling the luminance of each of the LEDs separately.

The display control circuit CNT applies a liquid-crystal driving voltage to the liquid-crystal layer between the pixel electrodes and the counter-electrodes via the array substrate and counter-substrate, thereby controlling the transmittance of each pixel by the generated electric field.

The display control circuit CNT includes a gate driver 11, a source driver 12, a frame memory 13, a video signal converter unit 14, a setting value memory 15, and a driving control unit 16.

The gate driver 11 drives gate lines (not shown) for selecting a plurality of pixels in rows sequentially. The selected row of pixels go into a state where the pixel voltage corresponding to the display signal can be written. The source driver 12 outputs the pixel voltage to be written into the pixels in each selected row to a plurality of source lines (not shown).

The frame memory 13 holds a display signal of each of R, G, and B extracted from the digital video signal. The video signal converter unit 14 creates a display signal for each of the four subfields of R, G, B, and W. The setting value memory 15 holds, in the form of a conversion table, setting data used to create a display signal for each of the four subfields.

The driving control unit 16 creates a pixel voltage from a display signal for each subfield obtained as a result of the conversion at the video signal converter unit 14 on the basis of the synchronous signal input from an external signal source (not shown) and outputs the pixel voltage as a source signal sequentially. The driving control unit 16 further generates a gate signal, a control signal to the gate driver 11, on the basis of the synchronous signal input from the external signal source. Furthermore, the driving control unit 16 outputs a synchronous signal for controlling the blinking of the R, G, B LEDs in each subfield on the basis of the synchronous signal input from the external signal source.

The basic concept of the invention will be explained using a case where four subfields of white (W) in addition to R, G, and B are driven.

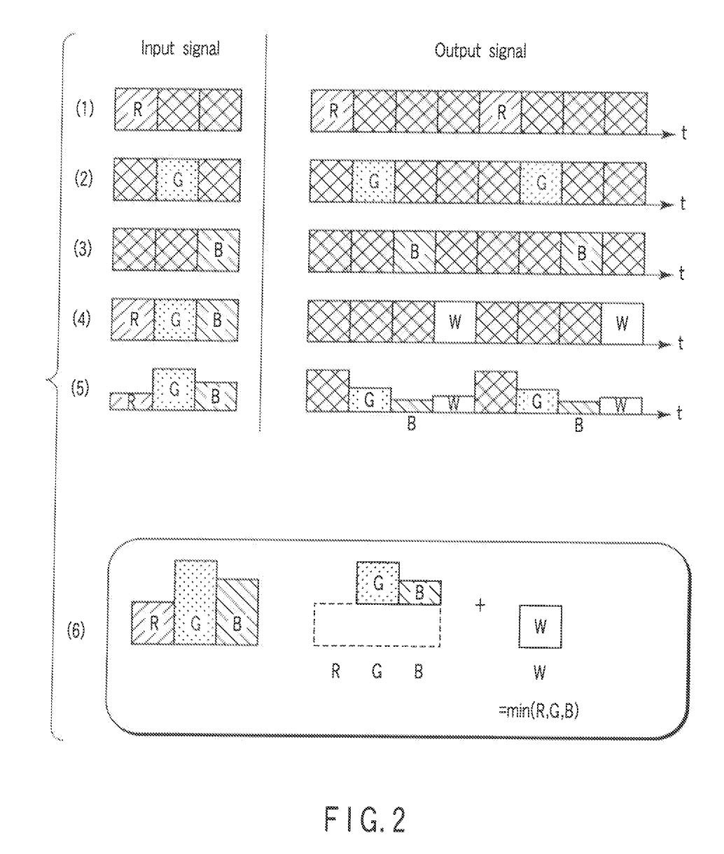

FIG. 2 is a diagram to explain a field sequential driving method using four subfields of RGBW as a comparative example.

The input signals of FIG. 2 show the display signal strength of each color of RGB in a color video signal input to the video signal converter unit 14. The output signals of FIG. 2 show the display signal strength of each color of RGBW created for each of the four subfields output in time sequence from the video signal converter unit 14.

The display signal strength is converted into a pixel voltage, which is used to control the transmittance. Therefore, the display signal strength corresponds to the luminance level of an image.

FIG. 2 (1) shows a case where a display signal is an R unicolor signal. An input signal has only an R component and has neither a G nor a B component. As for an output signal, an R display signal is output in a first subfield. In a second to a fourth subfield, a display signal whose strength is zero is output.

FIG. 2 (2) shows a case where a display signal is a G unicolor signal. An input signal has only a G component and has neither an R nor a G component. As for an output signal, a G display signal is output in a second subfield. In a first, a third, and a fourth subfield, a display signal whose strength is zero is output.

FIG. 2 (3) shows a case where a display signal is a B unicolor signal. An input signal has only a B component and has neither an R nor a G component. As for an output signal, a B display signal is output in a third subfield. In a first, a second, and a fourth subfield, a display signal whose strength is zero is output.

FIG. 2 (4) shows a case where a display signal is a W unicolor signal. In an input signal, all of the R, G, and B components have the same display signal strength. As for an output signal, a W display signal is output in a fourth subfield. In a first to a third subfield, a display signal whose strength is zero is output.

FIG. 2 (5) shows a case where a display signal is a color mixture signal. In an input signal, the display signal strength of each of the R, G, and B components is shown. As for an output signal, a display signal whose strength is zero is output in a first subfield. In a second to a fourth subfield, the display signal strength of each of G, G, and W is output.

FIG. 2 (6) shows a method of processing a signal in the case of (5). Of the R, G, and B components in the input signal, the strength of the R component whose display signal strength is the lowest is the strength of the display signal in the W subfield of the output signal. Then, the value obtained by subtracting the display signal strength of the R component from the display signal strength of each of the R, G, and B components is the display signal strength of each of the R, G, and B subfields in the output signal.

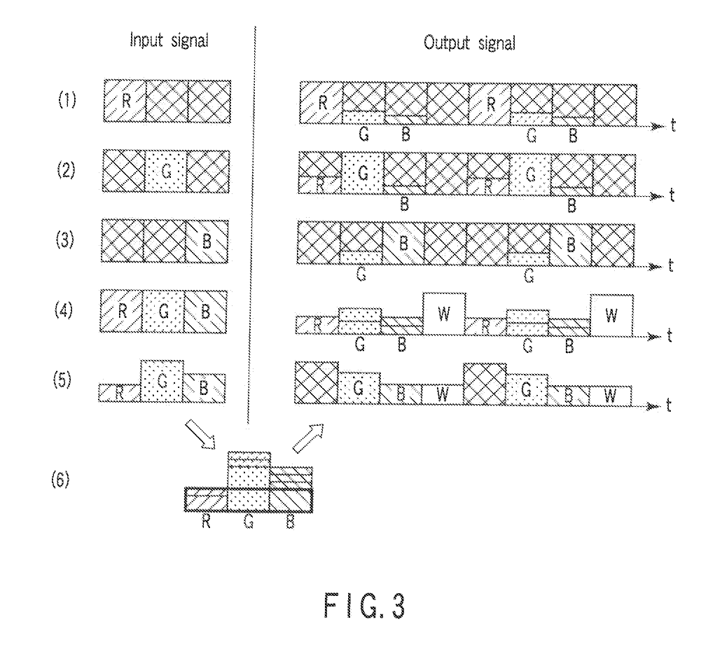

FIG. 3 is a diagram to explain a field sequential driving method using four subfields of RGBW in the liquid-crystal display device of the embodiment.

The input signals of FIG. 3 show the strength of the display signal of each color of RGB in a color video signal input to the video signal converter unit 14. The output signals of FIG. 3 show the strength of the display signal of each color of RGBW created for each of the four subfields output in time sequence from the video signal converter unit 14.

FIG. 3 (1) shows a case where a display signal is an R unicolor signal. An input signal has only an R component and has neither a G nor a B component. As for an output signal, an R display signal is output in a first subfield. In a second and a third subfield, display signals of the G and B components whose strengths are in a specific ratio are output. In a fourth subfield, there is no W component.

FIG. 3 (2) shows a case where a display signal is a G unicolor signal. An input signal has only a G component and has neither an R nor a B component. As for an output signal, a G display signal is output in a second subfield. In a first and a third subfield, display signals of the R and B components whose strengths are in a specific ratio are output. In a fourth subfield, there is no W component.

FIG. 3 (3) shows a case where a display signal is a B unicolor signal. An input signal has only a B component and has neither an R nor a G component. As for an output signal, a B display signal is output in a third subfield. In a first and a second subfield, display signals of the R and B components whose strengths are in a specific ratio are output. In a fourth subfield, there is no W component.

FIG. 3 (4) shows a case where a display signal is a W unicolor signal. In an input signal, all of the R, G, and B components have the same strength. As for an output signal, a W display signal is output in a fourth subfield. In a first to a third subfield, the values obtained by adding the display signal strength of each of R, G, and B in the above specific ratio are output.

FIG. 3 (5) shows a case where a display signal is a color mixture signal. In an input signal, the display signal strength of each of the R, G, and B components is shown. In an input signal, no R component is output in the first subfield. In a second to a fourth subfield, the display signal strength of each of G, B, and W is output.

FIG. 3 (6) shows a method of processing a signal in the case of (5). The display signal strength of each subfield is calculated from the strength value of each of the R, G, and B components in the input signal and then the strength is accumulated in each subfield. Of the accumulated values, the value of the smallest R component corresponds to the strength of the display signal in the W subfield of the output signal. Then, the value obtained by subtracting the value of the R component from the values of the R, G, and B components correspond to the strength of the display signal in each of the R, G, B subfields.

As described above, even in RGB unicolor display, the color gamut can be adjusted by displaying another color in a specific ratio of strengths. When colors other than one color are displayed, the strength of another color displayed in the unicolor display is accumulated and displayed, which makes it possible to increase the display brightness, while maintaining the adjusted color gamut.

Next, the field sequential operation of the liquid-crystal display device according to the embodiment will be explained with reference to FIG. 1.

The display signal of each of R, G, and B extracted from a digital video signal is stored in the frame memory 13. The video signal converter unit 14 uses the display signal held in the frame memory 13 as an input and generates a display signal for each of the four subfields of R, G, B, and W.

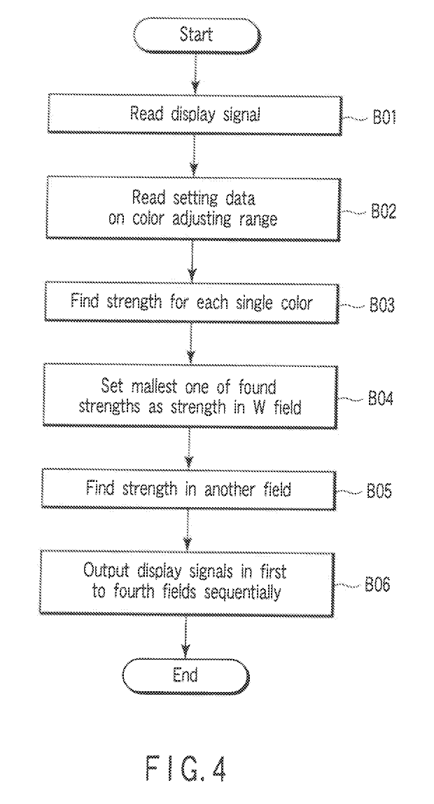

FIG. 4 is a flowchart to explain a rough procedure for the video signal converter unit 14.

In block B01, the video signal converter unit 14 reads the display signal of each of R, G, and B colors from the frame memory 13. Let the strengths of the display signals read in be Ra, Ga, and Ba, respectively. In block B02, a conversion table in which setting data on the color adjusting range has been written is read from the setting value memory 15.

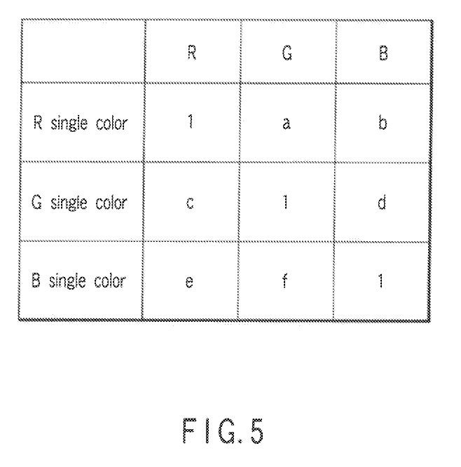

FIG. 5 is a diagram showing an example of setting data.

According to the setting data, in R unicolor display, in addition to the R component, the G component and B component are added in proportion a and proportion b, respectively, thereby creating a display. In G unicolor display, in addition to the G component, the R component and B component are added in proportion c and proportion d, respectively, thereby creating a display. In B unicolor display, in addition to the B component, the R component and G component are added in proportion e and proportion f, respectively, thereby creating a display.

Specifically, in unicolor display, using the maximum values Rm, Gm, and Bm of the individual color components, expressions (1) to (3) hold:
R unicolor display: Rm+a*Gm+b*Bm (1)
G unicolor display: c*Rm+Gm+d*Bm (2)
B unicolor display: e*Rm−f*Gm+Bm (3)

In block B03, the strength for each single color is found.

The display of each color is expressed by expressions (4) to (6) using the strengths Ra, Ga, and Ba of the individual colors read in as with expressions (1) to (3):
R display: Ra+a*Ga+b*Ba (4)
G display: c*Ra+Ga+d*Ba (5)
B display: e*Ra+f*Ga+Ba (6)

Accordingly, the values Rs, Gs, and Bs obtained by accumulating the strengths of the display signals of the individual colors are expressed by equations (7) to (9) using the strengths Ra, Ga, and Ba of the display signal of the individual colors read in:
Rs=(1+c+e)*Ra (7)
Gs=(a+1+f)*Ga (8)
Bs=(b+d+1)*Ba (9)

In block B04, of the values of the individual colors found by total, the smallest one is determined to be the strength of a display signal in the W subfield.

Specifically, the strength Wf of a display signal in the W subfield is expressed by equation (10):
Wf=Min(Rs,Gs,Bs) (10)

When Wf has exceeded a specific maximum value, Wf is determined to be the specific maximum value.

In block B05, the strength of a display signal in another subfield is found.

The strengths Rf, Gf, and Bf of display signals in the R, G, and B subfields are expressed by equations (11) to (13):
Rf=(1+c+e)*Ra−Wf (11)
Gf=(a+1+f)*Ga−Wf (12)
Bf=(b+d+1)*Ba−Wf (13)

In block B06, the found Rf, Gf, Bf, and Wf are determined to be the strengths of display signals in the first to fourth subfields and are output sequentially.

From expression (1) to equation (13), the operation of the video signal converter unit 14 is synonymous with the following: the signal strength (luminance level) of another RGB is increased by a specific proportion on the basis of the signal strength of the RGB single color read from the frame memory, the resulting RGB signal strength is used as a new display signal strength, and conventional four subfield processes are carried out.

The driving control unit 16 not only generates a pixel voltage from the display signal for each subfield obtained as a result of the conversion at the video signal converter unit 14 on the basis of the synchronous signal input from an external signal source (not shown) and outputs the voltage sequentially as a source signal but also further generates a gate signal, a control signal to the gate driver 11 for selecting the pixels in the corresponding row. Moreover, the driving control unit 16 generates a synchronous signal and turns on the R, G, and B light sources for each of the R, G, and B subfields. In the W subfield, the driving control unit turns on all of the R, G, and B light sources, thereby generating white light.

While the operation of the video signal converter unit 14 is carried out for each of the pixels, the value of the strength of the display signal for each color may be found for a plurality of pixels on a row basis and the smallest one of the resulting values may be determined to be Wf.

Furthermore, various conversion tables may be prepared in advance and setting data in the color adjusting range may be selected and used according to the user's specification.

Coefficients a, . . . , f used in equations (7) to (9) are real numbers equal to or larger than zero. Accordingly, when any one of the coefficients is zero, there is no increase in the strength (or luminance) of the corresponding color. According to the technical idea of the invention, the processing of the video signal converter unit 14 increases the strength of at least one of the colors. That is, at least one of coefficient a, . . . , f is not zero.

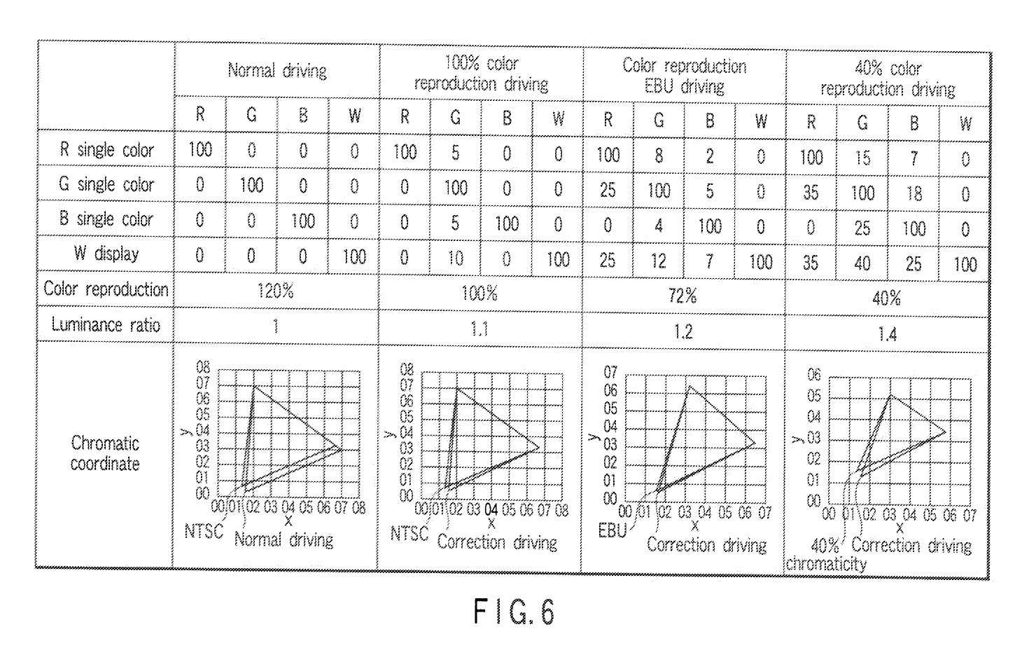

FIG. 6 shows practical examples using the liquid-crystal display device of the embodiment.

FIG. 6 (1) shows setting data, color reproductivity, luminance ratio, and chromatic coordinates in normal driving, that is, when other colors are not displayed in specific proportions in unicolor display.

In the embodiment, an LED element is used as light source 2. Accordingly, the color gamut is 120% in the NTSC ratio, producing vivid images. Since the luminance in the normal driving is used as a reference, the luminance ratio is 1.0. In the chromatic coordinates, an NTSC chromaticity diagram is overlapped with a chromaticity diagram in normal driving.

FIG. 6 (2) shows setting data, color reproductivity, luminance ratio, and chromatic coordinates when the color of G is displayed 5% in R and B unicolor display in correction driving.

In the embodiment, in the chromatic coordinates, the chromaticity diagram is almost the same as that of NTSC. Accordingly, the color gamut is 100% in the NTSC ratio, producing an image with a high color gamut. On the other hand, since other colors are mixed and displayed in unicolor display, the luminance ratio actually measured using the luminance in normal driving as a reference gives a high luminance of 1.1.

FIG. 6 (3) shows setting data, color reproductivity, luminance ratio, and chromatic coordinates when other colors are displayed as shown in the figure in R, G, and B unicolor display in correction driving.

In the embodiment, in the color coordinates, the chromaticity diagram is almost the same as that of the EBC standard used in ordinary broadcasting. Therefore, an image is obtained with a 72% color gamut in the NTSC ratio. On the other hand, since other colors are displayed in unicolor display, the luminance ratio actually measured using the luminance in normal driving as a reference is 1.2, producing a very bright image.

FIG. 6 (4) shows setting data, color reproductivity, luminance ratio, and chromatic coordinates when other colors are displayed as shown in the figure in R, G, and B unicolor display in correction driving.

In the embodiment, in the color coordinates, the chromaticity diagram is almost the same as that of 40% chromaticity. Therefore, an image is obtained with a 40% color gamut in the NTSC ratio. On the other hand, since other colors are displayed in unicolor display, the luminance ratio actually measured using the luminance in normal driving as a reference is 1.4, producing an extremely bright image.

As explained in the embodiment, the liquid-crystal display device of the embodiment can realize both a wide color gamut and a high luminance. Moreover, changing the setting data makes it possible to adjust not only the color gamut but also the luminance.

Accordingly, the user can obtain the desired image according to the intended use. For example, when wanting a vivid image, the user uses setting data that provides normal driving or 100% color reproduction driving. When wanting normal broadcast video, the user uses setting data that provides color reproduction EBU driving. When wanting high-intensity images for use outdoors or the like, the user uses setting data that provides 40% color reproduction driving.

This makes the characteristic of the design of a product to be sold stand out, which enables the product to have higher appeal power and the ability to pull in more customers. Since adjusting the color gamut requires only the change of the setting data, the data may be changed flexibly according to the image.

While in the embodiment, R, G, B, and W subfields, or four color subfields, have been used, more than four color subfields may be used. For example, not only R, G, and B but also cyan, magenta, and yellow (C, M, and Y), complementary colors, and W may be added to constitute subfields.

The display apparatus of the invention is not limited to the embodiment and may use an element making use of a Micro-Electromechanical System (MEMS).

For example, a Digital Micromirror Device (DMD) (registered trademark) used in DLP (registered trademark) may be used. A DMD is such that micrometer-size mirrors (or micromirrors) are laid as a reflecting plate on a CMOS semiconductor substrate. Each of the mirrors acts as a pixel, thereby forming an image. The micromirrors can be turned on and off at as high a speed as several thousands times per second, thereby changing the reflection angle of light. Accordingly, using the DMD as a backlight element and turning on and off light pixel by pixel by the reflection of the micromirrors enables a high contrast ratio to be realized.

Furthermore, a Grating Light Valve (GLV) (registered trademark) may be used in place of the liquid-crystal display element. A GLV is formed by arranging ribbon-like optical diffraction elements in a column on a silicon substrate. A pixel is composed of six ribbons. Attraction by electrostatic force enables the optical diffraction elements to be moved minutely. Changing the amount of optical diffraction makes it possible to create the light and dark parts of an image. The ribbon-like optical diffraction elements are manufactured by MEMS techniques.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display apparatus comprising:
a video signal converter unit which converts input video signals of n colors (n is an integer equal to or larger than 2) into converted video signals of at least (n+1) colors and which generates the converted video signals of (n+1) colors to improve the luminance of the input video signal of at least one color;
a display panel which displays (n+1) images sequentially on the basis of the converted video signals of (n+1) colors; and
a backlight which switches between light sources of (n+1) colors for illumination sequentially in accordance with the images displayed on the display panel.

2. The display apparatus according to claim 1, wherein the input video signals include three color video signal of red, blue, and green, and
the video signal converter unit converts into converted video signals of red, blue, green, and white.

3. The display apparatus according to claim 1, wherein the amount of change of luminance of the input video signal improved by the video signal generator unit is configured to be changeable.

4. The display apparatus according to claim 3, further comprising:
a memory which stores information indicating the amount of change; and
a rewrite unit which changes the information in the memory.

5. The display apparatus according to claim 3, further comprising:
a memory which stores a plurality of types of information indicating the amount of change; and
a specify unit which specifies information indicating the amount of change used in generating a new converted video signal.

6. A display apparatus comprising:
a video signal generator unit which, on the basis of individual input video signals of n colors (n is an integer equal to or larger than 2), generates input video signals of new n colors with the luminance of at least one of the input video signals being improved;
a video signal converter unit which converts the input video signals of the new n colors into converted video signals of at least (n+1) colors;
a display panel which displays (n+1) images sequentially on the basis of the converted video signals of (n+1) colors; and
a backlight which switches between light sources of (n+1) colors for illumination sequentially in accordance with the images displayed on the display panel.

7. The display apparatus according to claim 6, wherein the input video signals include three color video signal of red, blue, and green, and
the video signal converter unit converts into converted video signals of red, blue, green, and white.

8. The display apparatus according to claim 6, wherein the amount of change of luminance of the input video signal improved by the video signal generator unit is configured to be changeable.

9. The display apparatus according to claim 8, further comprising:
a memory which stores information indicating the amount of change; and
a rewrite unit which changes the information in the memory.

10. The display apparatus according to claim 8, further comprising:
a memory which stores a plurality of types of information indicating the amount of change; and
a specify unit which specifies information indicating the amount of change used in generating a new converted video signal.
